(19) United States
(12) Patent Application Publication
(10) Pub. No.: US 2025/0196150 A1
(43) Pub. Date: Jun. 19, 2025

(54) HYDRAULIC SYSTEM FOR JAW CRUSHER

(71) Applicant: SANDVIK LTD, Dungannon (GB)

(72) Inventors: Stuart GRAYDON, Dungannon (GB); Stuart SMYTH, Dungannon (GB); Adam BAXTER, Dungannon (GB)

(21) Appl. No.: 18/875,341

(22) PCT Filed: Jun. 21, 2023
(86) PCT No.: PCT/EP2023/066752

§ 371 Date: Dec. 16, 2024

(30) Foreign Application Priority Data
Jun. 21, 2022 (EP) 22180031.1

(51) Int. Cl. B02C 1/00; B02C 1/04; B02C 21/02

(52) U.S. Cl. CPC B02C 1/005; B02C 1/04; B02C 21/026

(57) ABSTRACT

In one aspect there is provided a jaw crusher including a motor providing a primary power source to a primary hydraulic pump of the jaw crusher, a crusher frame supporting a fixed jaw and a movable jaw defining a crushing chamber therebetween, a cross beam transversely mounted in the crusher frame, a toggle plate extending between the cross beam and the movable jaw, and a hydraulic system having a primary pump line powered by the primary hydraulic pump for moving the movable jaw and clamping the toggle plate. The hydraulic system includes an auxiliary pump powered independently of the primary pump for effecting movement of the movable jaw.

### FIELD OF INVENTION

Aspects of the invention relates to a hydraulic system configured to operate a jaw crusher independently of a primary power source. The invention also relates to a method of servicing or maintaining a jaw crusher. In further aspects, the invention relates to a jaw crusher service tool for supporting an item such as a toggle plate during service of the jaw crusher

### BACKGROUND OF THE INVENTION

A variety of different crushers have evolved for processing bulk material such as stone, minerals and both domestic and industrial waste including construction materials to generate a crushed product for subsequent processing or disposal.

Jaw crushers are generally made up of a fixed jaw and a movable jaw mounted in a crusher frame in which the movable jaw is movable relative to the fixed jaw to generate an impelling force to crush material in a crushing chamber defined between the two jaws. The jaw crusher includes a cross beam in the crusher frame and a toggle plate clamped between the cross beam and the movable jaw. A hydraulic system applies a load to the cross beam, which is transmitted to the movable jaw via the toggle plate to resist the forces generated during crushing. Jaw crushers can be mobile or stationary crushers where the mobile crushers are provided with a wheeled or tracked chassis and the stationary crushers are provided with a stationary crusher mainframe.

Jaw crushers require regular maintenance and service and, due to the forces to which the jaw crusher is subjected during use, components of the jaw crusher sometimes require assembly, disassembly, replacement or removal for servicing e.g. worn (typically after 3,000 to 4,000 hours of use) or damaged toggle plates may require removal and replacement. Due to the configuration of jaw crushers, such items must generally be manually removed and replaced from below. However, toggle plates and other jaw crusher components can be extremely heavy and cumbersome (e.g. toggle plates typically have a weight of about 100 kg) with the result that the manual handling of the items can present significant health and safety risks to service personnel.

Known jaw crushers are also equipped with hydraulic systems, powered by the jaw crusher motor, to effect movement of the movable jaw and to clamp a toggle plate between the movable jaw and the cross beam. Accordingly, in order to make the toggle plate available for removal, the jaw crusher motor is activated to lock open the movable jaw and is then switched off to allow manual access to the toggle plate. However, once the motor is switched off, the hydraulic fluid is returned through the hydraulic system under gravity resulting in closure of the movable jaw. This can also present a safety hazard to service personnel and reduce the time available to effect removal of the toggle plate.

An object of the invention is to provide a jaw crusher service tool to assist in the servicing of a jaw crusher to minimise health and safety risks. A further object of the invention is to provide a hydraulic system for a jaw crusher configured to effect movement of the movable jaw independently of the jaw crusher motor.

### SUMMARY OF THE INVENTION

In one aspect of the invention there is provided a jaw crusher service tool for supporting an item during service of a jaw crusher comprising a fixed jaw and a movable jaw mounted in a crusher frame and defining a crushing chamber for material to be crushed, the service tool comprising:
a support frame for supporting the item, and
a jaw crusher mounting attached to the support frame for mounting the service tool on a jaw crusher
wherein the support frame is movable about first and/or second articulation axes between a transport position and an item supporting position on the jaw crusher. The jaw crusher tool therefore allows for safe handling and manipulation of heavy components such as toggle plates, during servicing and maintenance operations.

Suitably, the support frame comprises a tool storage chamber for storing items in a transport cum storage position. The support frame can therefore serve a dual function as required—support and storage of various items.

In one embodiment, the first articulation axis comprises a horizontal pivot axis. The support frame can therefore be pivoted and positioned as required e.g. through 90° about the horizontal axis.

In any embodiment, the second articulation axis comprises a vertical pivot axis. The support frame can therefore be pivoted and positioned as required e.g. through 180° about the vertical axis.

In one embodiment, the mounting defines the horizontal pivot axis and the vertical pivot axis. The mounting therefore serves a dual function and ensures that the jaw crusher service tool is compact and space saving.

Suitably, the support frame comprises a platform. The platform defines a support surface for items.

In one embodiment, the support frame comprises an item grip or gripping an item. Items are therefore supported securely on the platform.

Optionally, the jaw crusher mounting is a detachable jaw crusher mounting. The jaw crusher service tool can therefore be removed and repositioned as required on the jaw crusher.

Suitably, the jaw crusher mounting is configured to be mountable on a crusher chassis or a crusher frame. The jaw crusher service tool can therefore be located in various positions on the jaw crusher.

The invention also extends to a jaw crusher comprising a jaw crusher service tool as hereinbefore defined.

In any embodiment, the jaw crusher comprises:
a motor providing a primary power source to a primary hydraulic pump of the jaw crusher;
a crusher frame supporting a fixed jaw and a movable jaw defining a crushing chamber;
a cross beam transversely mounted in the crusher frame;
a toggle plate extending between the cross beam and the movable jaw,
a hydraulic system having a primary pump line powered by the primary hydraulic pump for moving the movable jaw and clamping the toggle plate, and
a secondary primary pump line powered by the primary hydraulic pump for moving the movable jaw and unclamping the toggle plate
wherein the hydraulic system comprises an auxiliary pump powered independently of the primary pump for effecting movement of the movable jaw. The movable jaw can therefore be powered open to remain open as required without requiring operation of the motor to improve safety during maintenance operations.

Suitably, the auxiliary pump comprises a battery powered auxiliary pump. The auxiliary pump does not therefore require power via the motor.

In any embodiment, the battery powered auxiliary pump is a 24V maintenance pump.

In one embodiment, the auxiliary pump is in an accumulator block on the crusher frame. This ensures a faster response time for shock attenuation and a reduction in hydraulic hammer.

Suitably, the accumulator block comprises a shut-off valve to isolate the hydraulic system from the auxiliary pump as required. This prevents fluid from returning to tank during operation of the auxiliary pump.

In one aspect of the invention there is provided a jaw crusher comprising:
a motor providing a primary power source to a primary hydraulic pump of the jaw crusher;
a crusher frame supporting a fixed jaw and a movable jaw defining a crushing chamber;
a cross beam transversely mounted in the crusher frame;
a toggle plate extending between the cross beam and the movable jaw, and
a hydraulic system having a primary pump line powered by the primary hydraulic pump for moving the movable jaw and clamping the toggle plate;
wherein the hydraulic system comprises an auxiliary pump powered independently of the primary pump for effecting movement of the movable jaw. The movable jaw can therefore be powered open to remain open as required without requiring operation of the motor to improve safety during maintenance operations.

In any embodiment, the crusher further comprises a secondary primary pump line powered by the primary hydraulic pump for moving the movable jaw and unclamping the toggle plate.

Suitably, the auxiliary pump comprises a battery powered auxiliary pump. The auxiliary pump does not therefore require power via the motor. In any embodiment, the battery powered auxiliary pump is a 24V maintenance pump.

In one embodiment, the auxiliary pump is in an accumulator block on the crusher frame. This ensures a faster response time for shock attenuation and a reduction in hydraulic hammer.

Suitably, the accumulator block comprises a shut-off valve to isolate the hydraulic system from the auxiliary pump as required. This prevents fluid from returning to tank during operation of the auxiliary pump.

In another embodiment, the invention relates to a method of servicing or maintaining a jaw crusher having a motor providing a primary power source to a primary hydraulic pump of the jaw crusher; a crusher frame supporting a fixed jaw and a movable jaw defining a crushing chamber; a cross beam transversely mounted in the crusher frame; a toggle plate extending between the cross beam and the movable jaw and a hydraulic system having a primary pump line powered by the primary hydraulic pump for moving the movable jaw and clamping the toggle plate wherein the method comprises securing the movable jaw of the jaw crusher in an open position with a turnbuckle secured to the crusher frame. This allows for the safe servicing, installation and removal of other jaw crusher components during servicing/removal of the toggle plate.

In one embodiment, the method further comprises the step of moving the movable jaw into the open position with an auxiliary pump powered independently of the primary pump. Operation of the motor is not therefore required resulting in improved safety during maintenance operations.

### BRIEF DESCRIPTION OF THE DRAWINGS

The invention will now be described, by way of example only, with reference to the accompanying drawings in which:

FIG. 1 is a side elevation of a jaw crusher fitted with a jaw crusher service tool of the invention on the chassis of the jaw crusher with the jaw crusher service tool in the transport cum storage position;

FIG. 2 is an enlarged isometric view from above of the fixed and movable jaws and crushing chamber of the jaw crusher of FIG. 1;

FIG. 3 is an enlarged isometric view from the outside of the jaw crusher of the jaw crusher service tool on the chassis of the jaw crusher;

FIG. 4 is an enlarged isometric view of the jaw crusher service tool of FIG. 3 from the inside of the chassis of the jaw crusher with the item/tool storage chamber of the jaw crusher service tool visible;

FIG. 5 is an enlarged isometric view of the jaw crusher service tool of FIG. 3 separated from the chassis for clarity;

FIG. 6 is an isometric view of the jaw crusher service tool of FIG. 5 in the item supporting position;

FIG. 7 is an exploded isometric view of the jaw crusher service tool of FIG. 6;

FIG. 8 is an isometric view of the jaw crusher service tool of FIG. 3 rotated about the first and second articulation axes into the item supporting position;

FIG. 9 is an isometric view from inside the chassis of the support frame of the jaw crusher service tool of FIG. 8 rotated through 180° about the vertical pivot axis into an item working position in the interior of the chassis below the jaw crusher;

FIG. 10 is an enlarged view of an accumulator block with auxiliary pump of the hydraulic system of the jaw crusher of FIGS. 1 to 9, and

FIG. 11 is a side cross-sectional view a jaw crusher provided with the jaw crusher service tool of FIGS. 1 to 9 in the item supporting position and the accumulator block of FIG. 10 and in which the movable jaw is powered open by the auxiliary pump and the movable jaw is securely maintained in the open position by an optional turnbuckle.

### DETAILED DESCRIPTION OF THE INVENTION

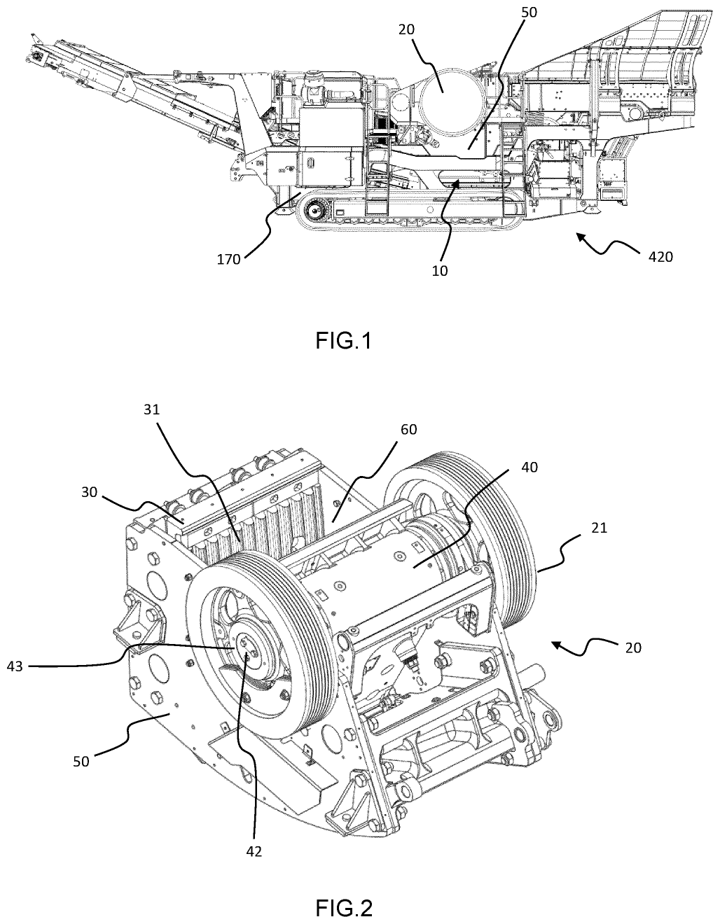

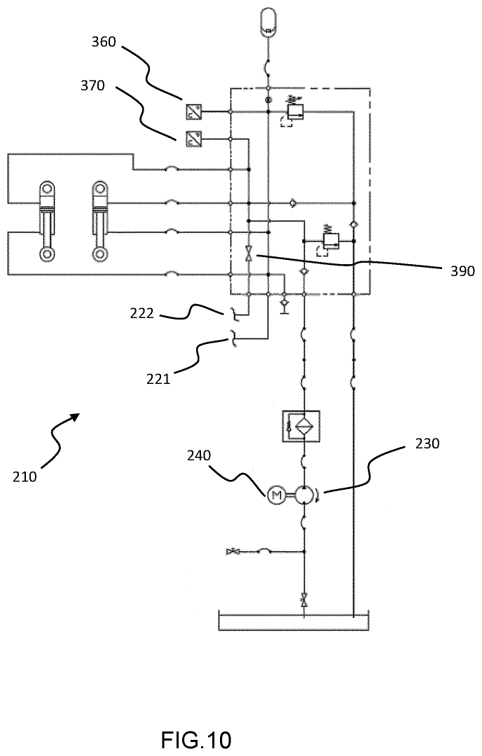

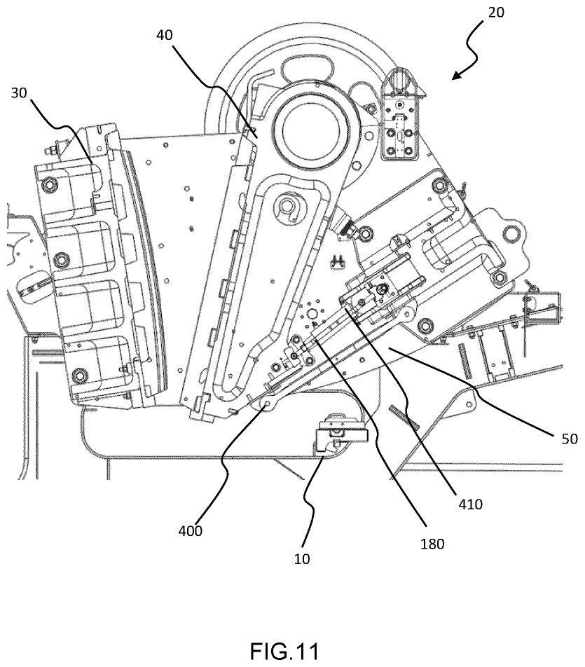

FIG. 1 shows a jaw crusher service tool 10 of the invention mounted on a mobile jaw crusher 420 and FIG. 2 shows an enlarged view of the workings of a jaw crusher 20 of the mobile jaw crusher 420. As shown in the drawings, the jaw crusher 20 is mounted on a mobile jaw crusher 420 provided with a chassis 170 on which is mounted a fixed jaw 30 and a movable jaw 40 in a crusher frame 50 and defining a crushing chamber 60 for material to be crushed. In the present embodiment, the jaw crusher tool 10 is mounted on the chassis 170. However, in other embodiments, the jaw crusher service tool 10 can be mounted elsewhere on the crusher frame 50 The jaws 30,40 are each provided with a wear plate 31,41 respectively. An upper end of the movable jaw 40 is connected to an eccentric shaft 42 rotatably received in a bearing 43 so that rotation of the eccentric shaft 42 causes circular motion of the upper end of the movable jaw 40 towards the fixed jaw 30 to generate the impelling force to crush materials in the crushing chamber 60. The inertia required to crush material fed to the jaw crusher 20 is provided by a weighted flywheel 21 operable to move the eccentric jaw crusher shaft 42 on which the movable jaw 40 is mounted. A jaw crusher motor is operative for rotating the flywheel 21 by means of a transmission belt. As will be appreciated by those skilled in the art, the jaw crusher 20 typically comprises a cross beam and a toggle plate arranged at the lower end of the movable jaw 40. The toggle plate is an extremely heavy item requiring regular servicing or replacement. The jaw crusher 1 further comprises a hydraulic system 210 (see FIGS. 10 and 11) for moving and positioning the movable jaw 40 to a desired position e.g. to a desired closed side setting (CSS) (the shortest distance between the wear plate 31 of the fixed jaw 30 and the wear plate 41 of the movable jaw 40) or another position. As shall be explained more fully below, the storable and articulatable jaw crusher service tool 10 of the invention on the mobile jaw crusher 420 aids in the safe servicing of the jaw crusher 20 from below by providing an easily accessible and available on demand support for heavy and cumbersome items such as the toggle plate during servicing operations while the hydraulic system 210 ensures that the movable 40 jaw can be powered open and powered closed independently of the jaw crusher motor to allow safe and controlled access to the toggle plate. The jaw crusher service tool 10 can also function as a storage device for other tools.

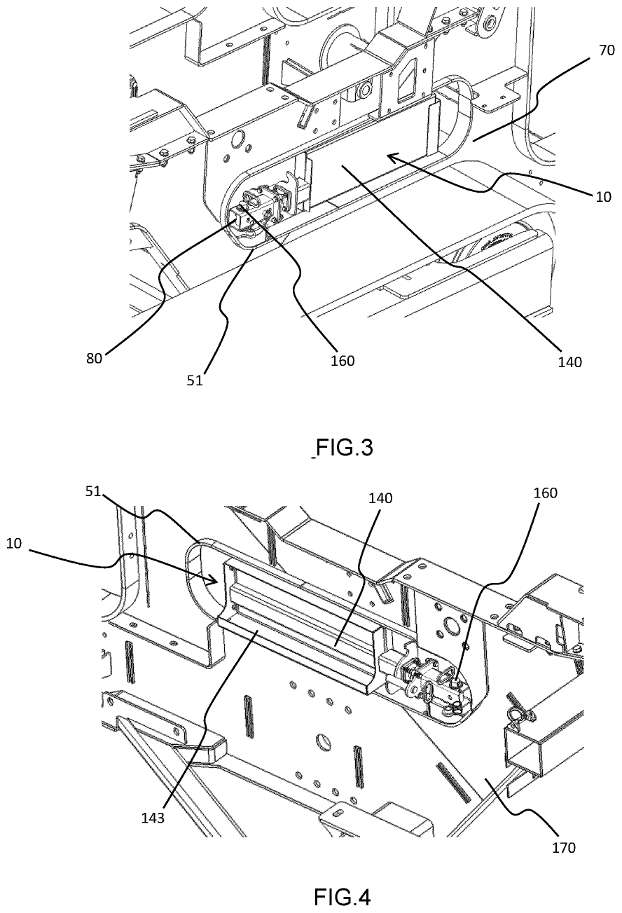

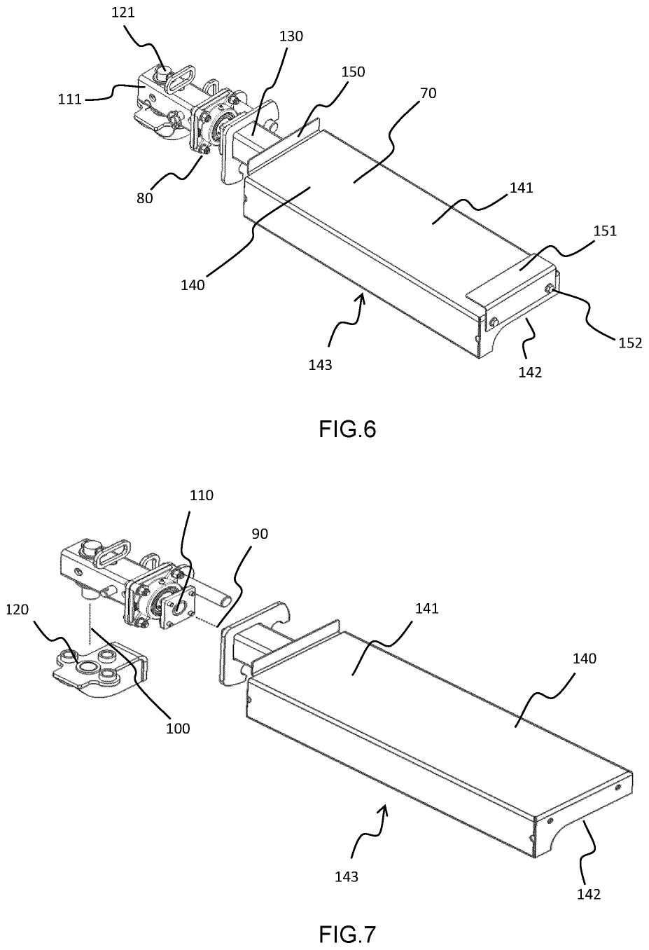

FIGS. 3 and 4 show opposite views of the jaw crusher service tool 10 of FIG. 1 on the chassis 170. As shown in the drawings, the jaw crusher service tool 10 is generally made up of a pivotable support frame 70 movable between a transport position shown in the drawings in which the support frame is recessed or retracted in a jaw service tool receiving opening 51 defined in the chassis 170 and an item supporting position in which the support frame 70 is extended or projects from the jaw service tool receiving opening 51 to receive and support items during servicing. The support frame 70 is provided with a crusher mounting 80, which can be a detachable mounting 160, for mounting the jaw crusher tool 10 on the chassis 170 for enabling movement of the support frame 70 about first and second articulation axes. In the present embodiment, the support frame 70 is in the form of a platform 140 for supporting items in the item supporting position. See also FIG. 6.

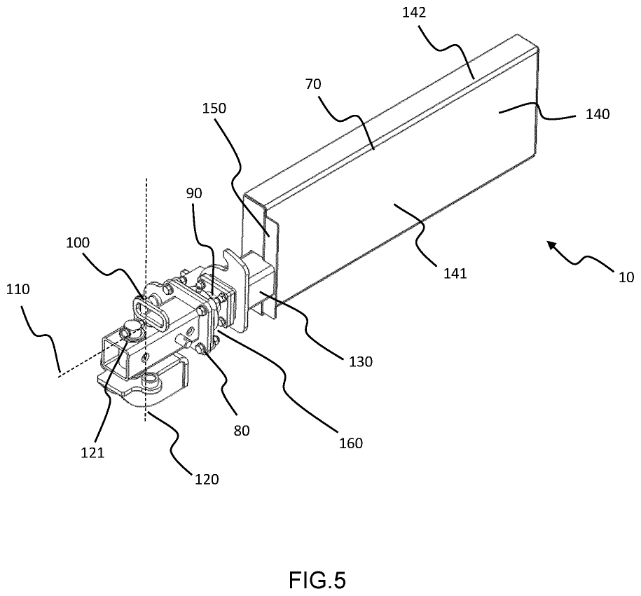

FIG. 5 shows the jaw crusher service tool 10 of FIG. 3 in the transport position separated from the chassis 170 for clarity. As shown in the drawing, the platform 140 of the jaw crusher service tool 10 and the jaw crusher mounting 80 are joined at an arm 130 from the platform 140 to the crusher mounting 80. The platform 140 is substantially rectangular in shape and has an upper flat support face 141 and a contoured rear face 142 defining a tool storage chamber 143 (see also FIG. 4). Accordingly, in the transport position, the jaw crusher tool 10 can also function as a storage container for an operative's tools and the like, particularly when the jaw crusher 20 is not operating and undergoing maintenance operations so that the transport position shown can also be an effective storage position if required i.e. a transport cum storage position.

The upper flat face 141 is provided with an upstanding grip 150 at its proximal end and an oppositely disposed L-shaped removable grip plate 151 at its distal end for gripping items such as toggle plates and the like between the grip 150 and grip plate 151 (see also FIG. 6). The removable grip plate 151 can be held in place by bolts 152. As shown in FIG. 5, the crusher mounting 80 is configured to define a first articulation axis 90 and a second articulation axis 100 so that the platform 140 can be moved between the transport position and the item supporting position on the chassis 170. In the present embodiment, the first articulation axis 90 is a horizontal pivot axis 110 and the second articulation axis 100 is a vertical pivot axis 120.

The horizontal pivot axis 110 is defined by a rotatable elongate horizontal tubular member 111 contiguous with the arm 130 and attached to the arm 130 via bolts 131 while the vertical pivot axis 120 is defined by a vertically disposed pin 121 extending through a pin opening 122 defined at the proximal end of the tubular member 111. The pin 121 is rotatably supported in a bracket 123 disposed beneath the tubular member 111 which also forms part of the mounting 80.

The platform 140 can be rotated about the horizontal pivot axis 110 from the transport position shown in FIG. 5 to the item supporting position shown in FIGS. 6 and 7. As shown in the drawings, in this position, the upper flat face 141 of the platform 140 is oriented upwards to receive items to be supported by the jaw crusher tool 10 such as toggle plates which can be held in place between the grip 150 and grip plate 151 if required and the contoured rear face 142 is oriented downwards.

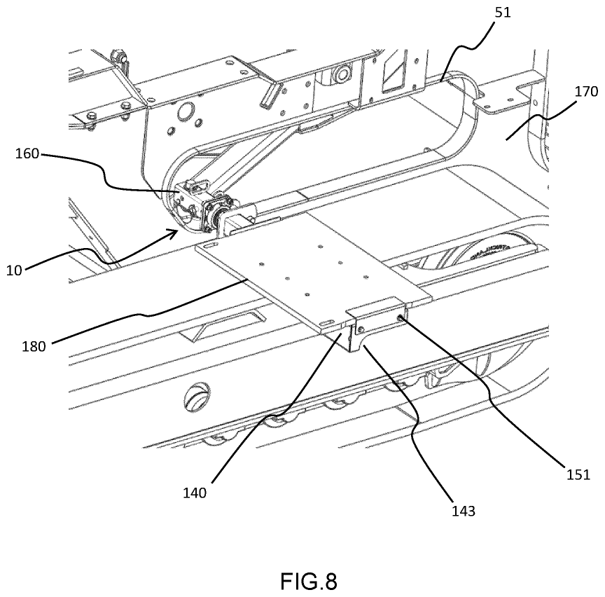

Accordingly, the jaw service tool 10 is movable from the transport position on the jaw chassis 170 shown in FIGS. 3 and 4 to the item supporting position shown in FIG. 8 about the horizontal pivot axis 110 and the vertical pivot axis 120.

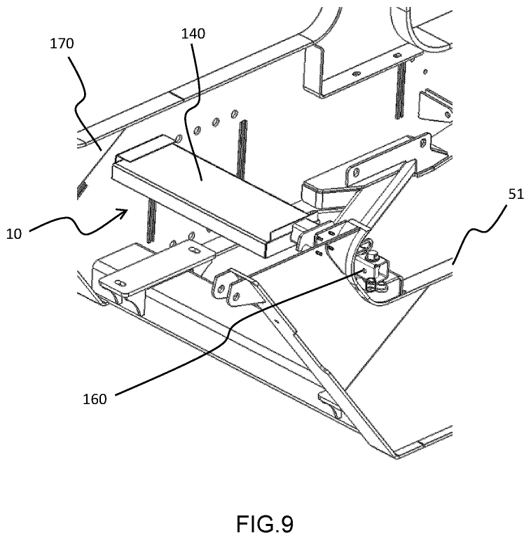

If required, the platform 140 can be rotated 180° about the vertical pivot axis 120 to project into the chassis 170 beneath the fixed jaw 30 and the movable jaw 40 to provide support for items as needed, e.g. where a toggle plate 180 is to be located beneath the movable jaw 40 for installation, the toggle plate 180 can be placed on the platform 140 as shown in FIG. 8 and the platform can then be rotated about the vertical pivot axis 120 to locate the toggle plate 180 adjacent the movable jaw 40 as shown in FIG. 9. Removal and replacement of the toggle plate 180 can therefore be performed in a safer manner than has been heretofore possible.

FIG. 10 shows an accumulator block 210 of the hydraulic system of the jaw crusher 20 in which the accumulator block 210 is provided with an auxiliary pump 230 powered independently of the hydraulic system primary pump for effecting movement of the movable jaw 40 during service operations so that the service operations can be performed without requiring activation of the jaw crusher motor which is required to provide power to the hydraulic system primary pump. The auxiliary pump 230 can be a battery powered auxiliary pump such as a 24V maintenance pump. A conventional hydraulic system 210 with no accumulator block 210/auxiliary pump 230 will be familiar to those skilled in the art in which an hydraulic system primary pump is in fluid communication with a primary pump line 221 for effecting toggle cylinder closure.

As shown in the drawing, the auxiliary pump 230 is in fluid communication with a second primary pump line 222 which effects opening of the toggle clamping cylinders independently of the first primary pump line 221 powered by the primary pump i.e. urges the toggle clamping cylinder pistons away from the toggle plate so that the toggle plate is released and can “fall out”. As a result, unlike the known operation of the movable jaw 40 in known jaw crushers, the toggle plate can be removed and the movable jaw 40 can be powered open. As shown in the drawing, the accumulator block 210 is also provided with an accumulator pressure transducer 360 and a toggle cylinder pressure transducer 370. Within the accumulator block 210 is also provided a shut-off valve 390 to isolate the hydraulic system from the auxiliary pump 230 as required and prevent fluid from returning to tank during operation of the auxiliary pump 230. The shut-off valve 390 is opened once service operations are complete to allow fluid flow during normal operation so that the toggle clamping cylinder pistons close under gravity after the shutoff valve 390 is opened i.e. trapped energy dissipated so that oil goes back to tank while the pressure transducer 370 can detect if the shutoff valve 390 is open or closed. However, when using the primary hydraulic pump, the cylinders can be powered open and closed/toggle plate clamped for crushing operations via the hydraulic system. In short, with the auxiliary pump 230, the movable jaw 40 can be maintained open as required and does not close as a result of the return of hydraulic fluid through the second primary pump line 222 when the motor is powered off. This results in significant improvements in safety for operatives performing service and maintenance operations. A further optional safety enhancement is that the shutoff valve 390 could be part of a lock out tag out safety procedure.

FIG. 11 shows a jaw crusher 20 similar to the jaw crusher 20 of FIGS. 1 to 9 provided with the jaw crusher service tool 10 in the item supporting position and the accumulator block 210 (not shown) of FIG. 10. Like numerals indicate like parts. As shown in the drawing, the movable jaw 40 is powered open by the auxiliary pump 230 as previously described. However, in order to further enhance personnel safety, the movable jaw 40 can be further secured in a fixed open position by an optional turnbuckle 400. The turnbuckle 400 is mounted beneath the toggle plate 180 and associated toggle clamping cylinders 410 and is secured at each end to the underside of the crusher frame 50 and movable jaw 40 either side of the toggle plate 180.

The accumulator block 210 can be located on the crusher frame 50 to ensure a faster response time for shock attenuation and a reduction in hydraulic hammer.

1. A jaw crusher comprising:
a motor providing a primary power source to a primary hydraulic pump of the jaw crusher;
a crusher frame supporting a fixed jaw and a movable jaw, the fixed jaw and the movable jaw defining a crushing chamber;
a cross beam transversely mounted in the crusher frame;
a toggle plate extending between the cross beam and the movable jaw: and
a hydraulic system having a primary pump line powered by the primary hydraulic pump for moving the movable jaw and clamping the toggle plate, wherein the hydraulic system includes an auxiliary pump powered independently of the primary pump for effecting movement of the movable jaw.

2. The jaw crusher according to claim 1, further comprising a secondary primary pump line powered by the primary hydraulic pump arranged for moving the movable jaw and unclamping the toggle plate.

3. The jaw crusher according to claim 1, wherein the auxiliary pump is a battery powered auxiliary pump.

4. The jaw crusher according to claim 3, wherein the battery powered auxiliary pump is a 24V maintenance pump.

5. The jaw crusher according to claim 3, wherein the auxiliary pump is in an accumulator block located on the crusher frame.

6. The jaw crusher according to claim 5, wherein the accumulator block includes a shut-off valve to isolate the hydraulic system from the auxiliary pump as required.

7. A method of servicing or maintaining a jaw crusher, the method comprising:
providing the jaw crusher, the jaw crusher having a motor providing a primary power source to a primary hydraulic pump of the jaw crusher, a crusher frame supporting a fixed jaw and a movable jaw, the fixed jaw and the movable jaw defining a crushing chamber, a cross beam transversely mounted in the crusher frame, a toggle plate extending between the cross beam and the movable jaw, and a hydraulic system having a primary pump line powered by the primary hydraulic pump for moving the movable jaw and clamping the toggle plate; and
securing the movable jaw of the jaw crusher in an open position with a turnbuckle secured to the crusher frame.

8. The method according to claim 7, further comprising the step of moving the movable jaw into the open position with an auxiliary pump powered independently of the primary pump.
